(19) United States
(12) Patent Application Publication
(10) Pub. No.: US 2005/0099497 A1
(43) Pub. Date: May 12, 2005

(54) System and method for producing image print

(76) Inventors: Kevin P. Rogan, Los Gatos, CA (US); Peter Charles Elarde, Newark, CA (US); Gary L. Leung, San Francisco, CA (US); Russ Ennio Muzzolini, San Carlos, CA (US); Su M. Quek, San Francisco, CA (US); Patrick C. Teo, San Mateo, CA (US)

Correspondence Address: XIN WEN, 3449 RAMBOW DRIVE, PALO ALTO, CA, 94306, US

(21) Appl. No.: 10/706,217

(22) Filed: Nov. 12, 2003

(51) Int. Cl. H04N 5/225

(52) U.S. Cl. 348/207.2

(57) ABSTRACT

A method is provided for producing a preview image for printing an input digital image having a first aspect ratio. The method includes providing a print format having a second aspect ratio different from the first aspect ratio, calculating a printable image portion of the input digital image for the print format, and displaying the printable image portion of the digital image for preview prior to printing an image print at the print format.

### CROSS-REFERENCES TO RELATED INVENTIONS

The present invention is related to commonly assigned U.S. Pat. No. 6,587,596 “System and method of cropping an image”, U.S. Pat. No. 6,583,799 “Image Uploading”, U.S. patent application Ser. No. 09/721,484, filed on Nov. 22, 2000, titled “User Interface and Methods for On-line Print Service”, U.S. patent application Ser. No. 09/560,609, filed on Apr. 28, 2000, titled “System and Method of Providing a User Interface for Changing Attributes of an Image-based Product”, U.S. patent application Ser. No. 09/684,595, filed on Oct. 5, 2000, titled “Previewing a framed image print”, U.S. patent application Ser. No. 9/972,602, filed on Oct. 5, 2000, titled “Managing and searching digital images”, U.S. patent application Ser. No. 10/106,902, filed on Mar. 25, 2002, titled “Producing and sharing personalized photo calendar”, and U.S. patent application Ser. No. 10/185,862, filed Jun. 28, 2002, titled “Personalized photo greeting cards”. The disclosures of these related applications are incorporated herein by reference.

### TECHNICAL FIELD

This disclosure relates to a method and system of cropping an image, specifically a method and system for preventing image content loss in producing an image print from a previewed digital image.

### BACKGROUND

Images can be generated in several ways. For example, an image can be captured using a film-based or digital camera and/or created and edited using image processing software. Images captured using a film-based camera typically are stored as film negatives. Images captured using a digital camera typically are stored as digital files residing in the memory of the digital camera and/or a storage medium to which the file has been transferred (for example, a hard drive or CDROM). Images created using image processing software are typically stored as a digital file residing on a computer readable medium such as a hard drive.

An image-based product can be generated from such stored images. As used here, the term “image-based product” refers to an item, regardless of medium, that includes a visual representation of at least a portion of one or more images. One example of an image-based product is an image print (also referred as photograph or photographic print). Other image-based products include, but not limited to, greeting cards, post cards, photo calendars, photo albums, snapbooks, photo frames, photo mugs, photo mouse pad, photo T-shirt, imaging cakes, photo archive CDs.

When a customer wishes to have a high-quality image print generated from a digital image, the customer needs not physically take the digital image to a photo-finishing laboratory and instead can electronically transmit the digital image to an “online” photo-finishing laboratory using a computer network such as the Internet. The customer can use an Internet browser program. The customer can direct the browser to a web site associated with the photo-finishing service provider and upload the digital image to a server hosting the web site. The photo-finishing service provider can then take the digital image from the web server and produce a high-quality image print from the digital image in a conventional manner.

Digital imaging technologies allow users to preview images on electronic displays before the images are printed. The digital images may exist in different dimensions and aspect ratios depending on the image capture devices. Digital images and image prints are typically in rectangular shapes. The aspect ratio of an image, or digital image, or an image print is the ratio of the two dimensions of the rectangular image area. Typically, an aspect ratio is the ratio of the long dimension over the short dimension of the image area. For example, digital cameras may have different image sensor dimensions. Typical aspect ratios of the consumer digital cameras include 1.33 (4:3) and 1.5 (3:2). The dimensions of scanned digital images are dependent on the dimensions of the area scanned. Typical photographic print formats include 4″×6″, 5″×7″, 8″×10″, 11″×14″ and so on. The digital images need to be cropped to the proper aspect ratios of the output print format before the digital images can be printed.

A long recognized problem in previewing and printing digital images is that a portion of the image content that is visible in preview may be lost on the printed image. For example, a user may see the face of a person near the top edge of an image in a preview on an electronic display when he selects the digital image for printing. In preparing for printing, the top portion of the digital image is cropped off. The user is surprised to find that part or all of the person's face is cropped off on the printed image. The above described undesired cropping has been a source of frequent customer complaints to photo printing services.

### SUMMARY

Methods and apparatus are disclosed for printing an input digital image having a first aspect ratio, comprising
a) providing a print format having a second aspect ratio different from the first aspect ratio;
b) calculating a printable image portion of the input digital image for the print format; and
c) displaying the printable image portion of the digital image for preview prior to printing an image print at the print format.

In one aspect, the present invention solves a long felt need in the digital photo-finishing field: portion of the image content viewable in an image preview is often lost when the image is reproduced on an images print. The present invention provides an improved system and methods for previewing digital images of different aspect ratios and printing the digital images at different print formats (i.e. “safe cropping”). The present invention allows all the image content viewable to the user in a preview of the digital image to be printed on an image receiver, independent of the format of the image prints. No image content is lost from previewing to printing.

In another aspect of the present invention, a system and methods are provided to properly process digital images for digital printing at different print formats. The aspect ratio and the image area of the preview image of a digital image are calculated using a predetermined algorithm that accounts for all the print formats available in the system. A portion of the image content of the original digital image is displayed for preview to prevent unwanted cropping of images in printing. After the user selects the print format at certain aspect ratio, the un-displayed image portions are patched with the displayed image portion to make up to the correct aspect ratio. The printed image content is therefore always equal or more than what's displayed. No image content is lost from preview to printing.

In yet another aspect, the present invention provides improved (“safe cropping”) methods for applying image borders to digital images for digital printing. The aspect ratio of the image portion within an image border on the final image print is calculated based on the aspect ratio of the print format and the border widths. The aspect ratios of the visible image portion within the image border are calculated for all print formats. The maximum printable image portion is determined for each print format for an input digital image. Only the common safe preview portion is displayed for preview.

The details of one or more implementation of the invention are set forth in the accompanying drawings and the description below. Other features, objects, and advantages of the invention will be apparent from the description and drawings, and from the claims.

### DESCRIPTION OF DRAWINGS

FIG. 1 is a flow diagram for producing a preview image for printing a digital image safe from image content loss in cropping in accordance with the present invention.

FIG. 2 illustrates an example of printable image area and un-printable image area for an input digital image and a selected print format in accordance with the present invention.

FIG. 3 illustrates another example of printable image area and un-printable image area for an input digital image and a selected print format in accordance with the present invention.

FIG. 4 illustrates the selection of the location for the maximum printable image portion for a print format.

FIG. 5 illustrates the determination of common safe preview portion to a plurality of print formats.

FIG. 6 is a flow diagram for producing a preview image for printing a digital image with an image border safe from image content loss in cropping in accordance with the present invention.

FIG. 7 illustrates the determination of effective aspect ratio for an input digital image having an image border that is printed at a selected print format in accordance with the present invention.

FIG. 8 is a flow diagram for producing digital print in a user selected print format safe from image content loss in cropping in accordance with the present invention.

### DETAILED DESCRIPTION

Various implementations of the systems and techniques described here may be realized in digital electronic circuitry, or in computer hardware, firmware, software, or in combinations thereof. A system or other apparatus that uses one or more of the techniques and methods described here may be implemented as a computer-readable storage medium, configured with a computer program, where the storage medium so configured causes a computer system to operate on input and/or generate output in a specific and predefined manner. Such a computer system may include one or more programmable processors that receive data and instructions from, and transmit data and instructions to, a data storage system, and suitable input and output devices. Each computer program may be implemented in a high-level procedural or object-oriented programming language, or in assembly or machine language if desired; and in any case, the language may be a compiled or interpreted language. Suitable processors include, by way of example, both general and special purpose microprocessors.

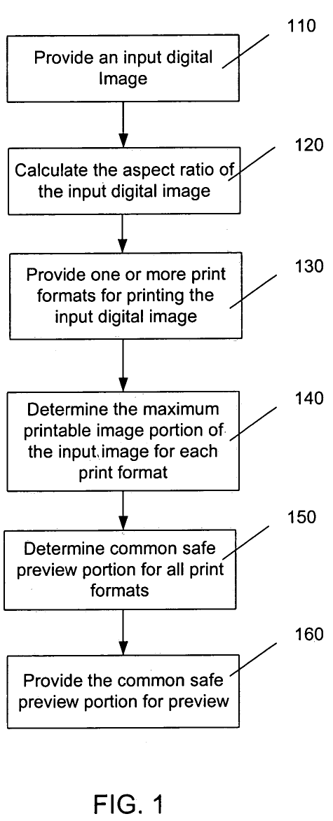

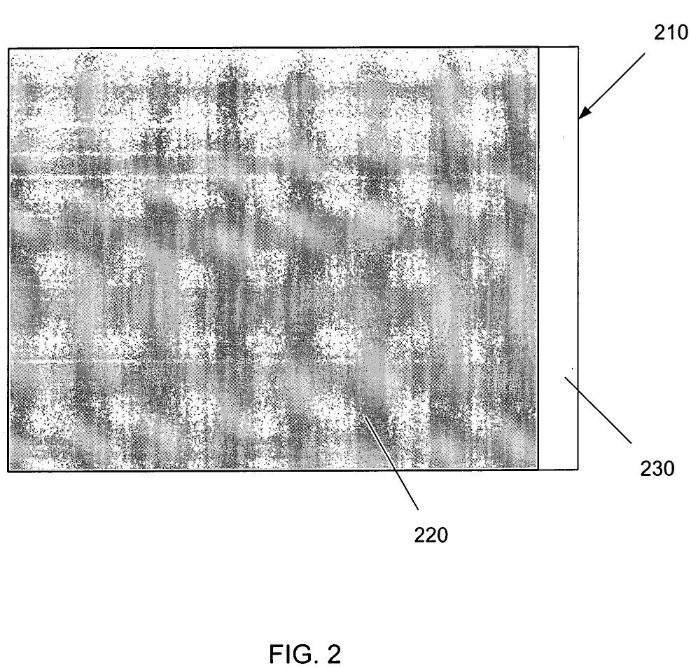

FIG. 1 is a flow diagram for producing a preview image for printing a digital image safe from image content loss in cropping (i.e. “safe cropping”) in accordance with the present invention. An input digital image is provided in step 110 by a user or a photo-finishing service provider. The input digital image can be produced by different image capture devices such as digital cameras, digital video cameras, mobile imaging devices such as camera phones, reflective image scanners, or photographic film scanners. The dimensions and the aspect ratios of the input digital image can thus vary depending on the capture devices and the area scanned. In the example illustrated in FIG. 2, the input digital image 210 is 2000 pixel in width and 1500 pixel in height, which gives an aspect ratio of 1.33 (as calculated in step 120 in FIG. 1). According to the present application, the aspect ratio of an image is the ratio of the long dimension (the width) divided by the short dimension (the height) of the image, which is applicable to digital images and images printed on physical receivers.

The user can order prints of different print formats to be made using the digital image by the photo-finishing service provider in step 130 of FIG. 1. Typical print formats include 3.5″×5″, 4″×6″, 5″×7″, 8″×10″, 11″×14″ and so on. The print formats possess different aspect ratios (e.g. 10:7, 6:4, 7:5, 10:8, 14:11, etc.), which may be different from the aspect ratio of 4:3 of the input digital image 210 in FIG. 2.

As previously described, a problem in the digital photo printing industry is the undesired image content loss in printing digital images. For a selected print format, any portion of the input image with the same aspect ratio as that of the selected print format is a printable image portion. The maximum printable image portion is a printable image portion with the most possible information of the input image. Any portion of the input image outside the maximum printable image portion is the un-printable image portion.

For example, to produce an 8″×10″ image print, a digital image having an aspect ratio of 1.25 (10:8) is required. The maximum printable image portion 220 for an 8″×10″ print format is determined in step 140 as illustrated in FIG. 2. While the maximum printable image portion 220 has the same height of 1500 pixel as the input digital image 210, the width of the maximum printable image portion 220 is 1875 pixels, shorter than the width of the input digital image 210. As a result, a portion 230 of the input digital image 210 is unprintable on an 8″×10″ print. In other words, the unprintable portion 230 needs to be cropped off of the input digital image 210 in preparing for a 8″×10″ print. If the whole input digital image 210 is displayed in a print preview to the user, the user may be unpleasantly surprised by the unexpected image loss after he or she receives the 8″×10″ print.

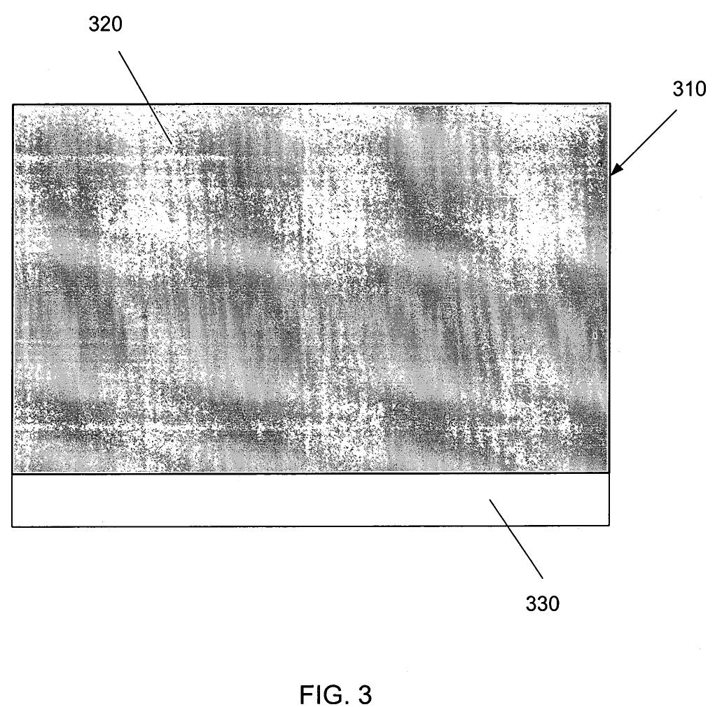

FIG. 3 illustrates another example of a printable image portion and an unprintable image portion in the input digital image 310 for producing a 4″×6″ print. Since a 4″×6″ print has a higher aspect ratio (1.5) than that (1.33) of the input digital image 310, the maximum printable image portion 320 has the same width but a lower height than the input digital image 310. An unprintable image portion 330 exists below the maximum printable image portion 320.

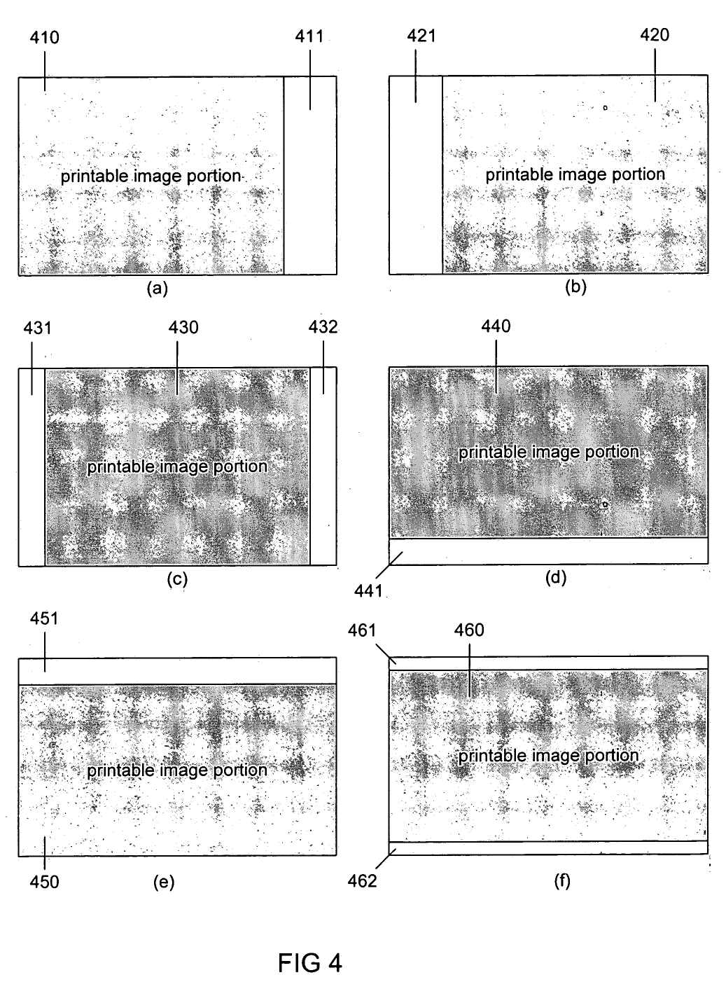

Although the maximum printable image portion 220 is shown to be aligned to the left edge of input the digital image 210, the maximum printable image portion 220 can be at any other horizontal positions as long as the full width of the maximum printable image portion 220 is within the input digital image 210. This is illustrated in FIG. 4(a), (b) and (c). FIG. 4(a) shows the unprintable image portion 411 is located to the right side of the input image while the maximum printable image portion 410 is aligned to the left of the input image. FIG. 4(b) shows that the unprintable image portion 421 is located to the left side of the input image while the maximum printable image portion 420 is aligned to the right edge of the input image. FIG. 4(c) shows that the unprintable image portion is split into two parts 431 and 432, aligning on both the left and right edges of the input image, with the maximum printable image portion 430 in the middle.

Similarly, the location the unprintable image portion 330 in FIG. 3 is just one of many possibilities for the unprintable image portion to be located. As illustrated in FIG. 4(d), (e) and (f), the unprintable image portion 441 can be aligned at the bottom of the input image, or the unprintable image portion 451 can be aligned at the top of the input image, or the unprintable image portion can be split into two parts 461 and 462, aligning at both the top and the bottom of the input image, leaving the maximum printable image portion in the middle.

It is the user's choice to select the best location of the maximum printable image portion of an input image for the preview.

The present invention is applicable to portrait and landscape image orientations. The problem of the image content loss may exist in different forms for the portrait and landscape image orientations. For example, in FIG. 2, a digital image 210 in landscape orientation will lose the image portions on the two sides after printing. Whereas a digital image 210 in portrait orientation will lose image portions in the top and/or bottom portion of the image. The present invention as described below provides solutions to both situations.

In accordance with the present invention, the preview image displayed to the user is kept equal to or smaller than the maximum printable image portion for the print format. Since only the whole or part of the maximum printable image portion is previewed, all the image content that is visible to a user in preview can be printed. The problem of unexpected image content loss is prevented.

In accordance with one embodiment of the present invention, the preview image can be specific to a user-selected print format. For example, if a user selects an 8″×10″ print for the input digital image 210, an image area equal to or smaller than the maximum printable image portion 220 (FIG. 2) is displayed for preview. The photo-finishing service may align the preview area to the left, the right, or around the center of the digital image 210. The user may also be allowed to slide the maximum printable image portion 220 to a horizontal location as he or she chooses. Furthermore, the preview image can be smaller than the maximum printable image portion 220 as long as it maintains the aspect ratio of the print format as selected by the user.

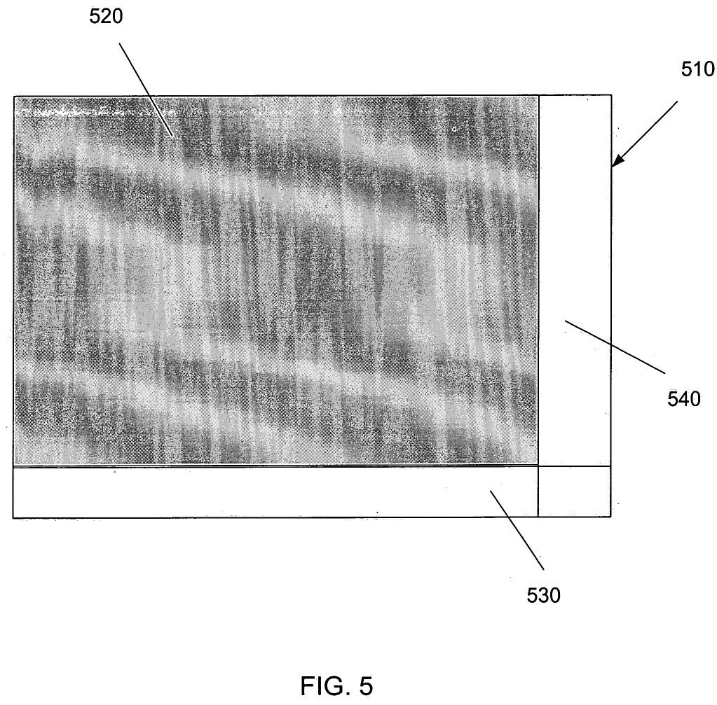

In accordance with another embodiment of the present invention, the preview image is selected to be within the image portion printable to all print formats (step 160 in FIG. 1). When the same input image is to be printed in a plurality of print formats, the overlap portion of the maximum printable portions of all the prints formats is the common safe preview portion. FIG. 5 illustrates how the common safe preview portion is determined (step 150 in FIG. 1). The maximum common safe preview portion 520 in the digital image 510 is the overlapping area of the maximum printable image portion 220 for the 8″×10″ print and the maximum printable image portion 320 for the 4″×6″ print. The total unprintable image areas include the unprintable image portion 530 (due to 4″×6″ print format) and the unprintable image portion 540 (as a result of 8″×10″ print format). The preview image area is selected to be equal or smaller than the maximum common safe preview portion 520. The same approach is applicable to the determination of maximum common safe preview portion 520 for more than two print formats.

The advantage of this embodiment is that one preview image is provided for previewing all available print formats while guaranteeing no image content loss from the previewed image in printing (i.e. safe cropping).

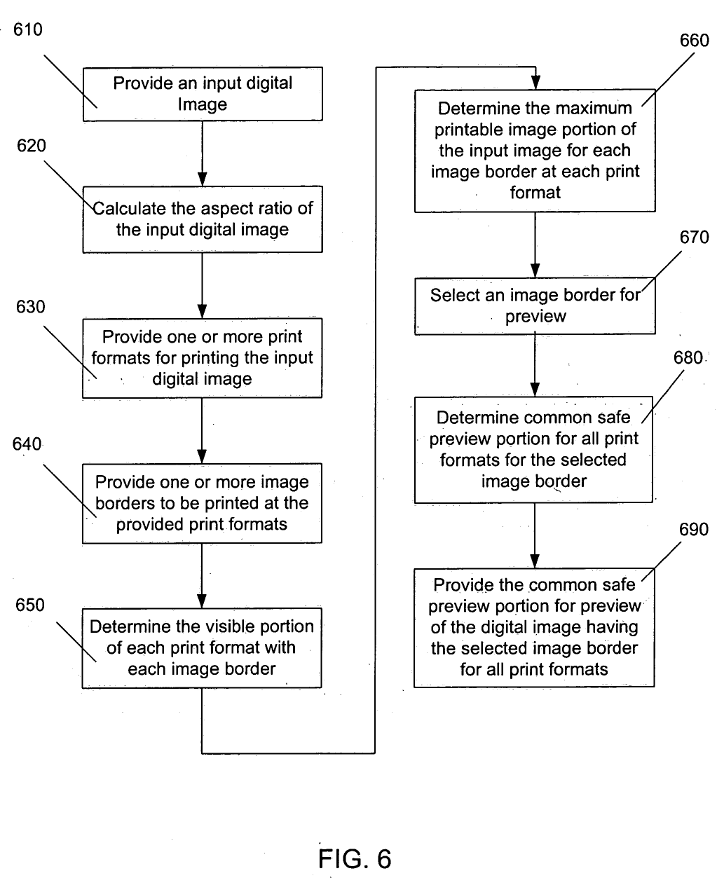

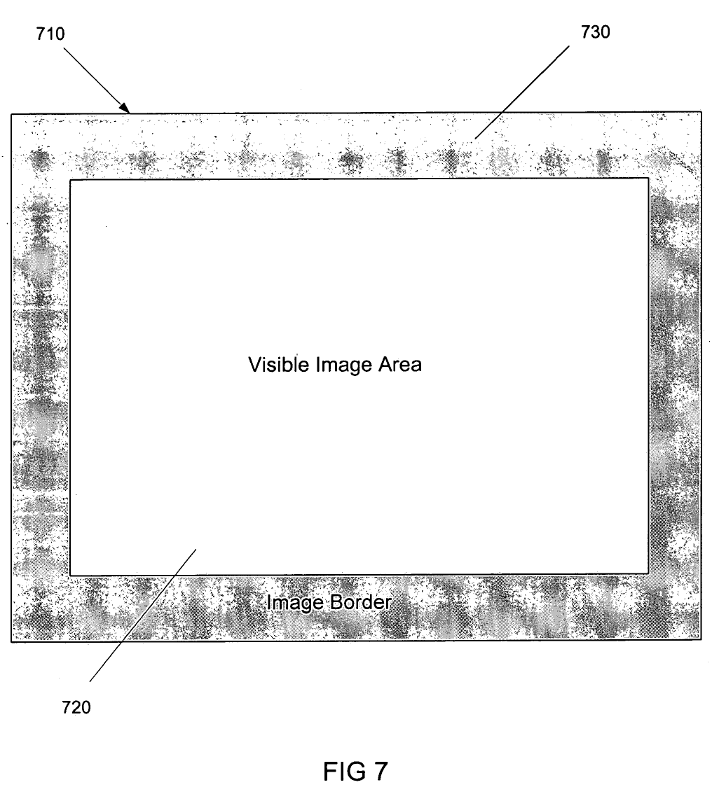

The present invention is applicable to previewing and printing an input digital image having an image border. In accordance with the present invention, the image border can exist in different designs such as art borders (shadow, blur, black lines etc.), even and uneven border widths around the four sides of the image, or image borders along any number of the four sides. Examples of border designs are provided by Shutterfly, Inc. at “www.shutterfly.com”. The borders can also carry themes like holidays, wedding, birthday, “Thank You”, “Welcome”, etc. Another example is a 4″×8″ holiday card having a 2″×4″ area on one side (typically the right end) and a 6″×4″ image area with or without additional image border. FIG. 6 is a flow diagram showing the process of printing a input digital image with an image border. In step 610, the user or the photo finishing service provides an input digital image. The input digital image's aspect ratio is calculated in step 620. One or more print formats are provided to the user in step 630, followed by step 640 in which one or more image borders (FIG. 7) are provided to the user for each print format.

For each print format coupled with each available image border, as shown in FIG. 7, the visible image area 720 of the input digital image is simply the whole image area of the image print 710 subtracted by the area of the image borders 730 (step 650 in FIG. 6). In accordance with the present invention, the widths of the image borders can be different along each side of the image print. The widths of the image borders can be zero along one or more sides. The widths of the image borders can also vary for different print formats for achieving the best visual effects at different print formats. For example, the absolute image border widths may desirably be broader for 8″×10″ format than for 4″×6″ so the image borders and visible image area look proportional to each other.

Returning to FIG. 6, based on the information from step 650, the maximum printable image portion for each print format coupled with each image border format is determined in step 660. As the printable image portion of the input digital image with an image border depends on the aspect ratio of the visible image area within the image border at that print format, the effective aspect ratio (rather than the aspect ratio of the print format itself) is used to determine the maximum printable image portion. An effective aspect ratio is used to describe the visible image area for a specific image border at a specific print format.

FIG. 7 illustrates the determination of the effective aspect ratio for the visible image area within an image border that is printed at a selected print format. The image print 710 is printed at an exemplified 4″ by 6″ print format. The image print 710 includes a visible image area 720 and an image border 730. In general, the widths of the image border 730 can vary on each of the four sides of an input image. For illustration purpose, assuming the image border 730 is of a uniformly 0.5″ width along each direction, the visible image area 720 is then 3″×5″ in dimension. The effective aspect ratio of the visible image area 720 is then 5:3 or 1.66. When images are printed with image borders, the effective aspect ratio of the visible image area 1.66 is used to calculate a printable image portion in an input digital image for each print format using the same approach as described in relation to FIGS. 2 and 3. The common safe preview portion in the input digital image for all print formats is determined following the same path as described in relation to FIG. 4. Only the printable image portion and the common safe preview portion in the input digital image are displayed for preview prior to producing an image print.

In step 670 of FIG. 6, the user selects an image border for preview of all print formats of an input image. The common safe preview portion for all print formats for the selected image border is determined in step 680 using the effective aspect ratio of the visible image area for the selected image border and the procedure described in relation to FIGS. 1-4. Finally, the common safe preview portion is provided to the user for preview for all print formats for the selected image border in step 690.

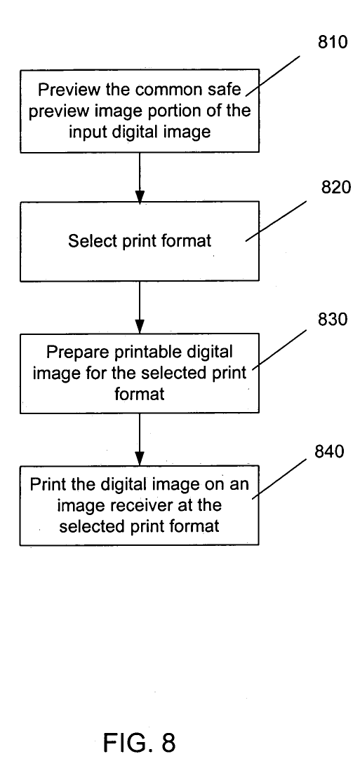

FIG. 8 is a flow diagram for producing digital print in a user selected print format safe from image content loss in cropping in accordance with the present invention. After the maximum printable image portion is generated, the user can preview the common safe preview portion of the input image in step 810 of FIG. 8. Based on the preview, the user selects the print format in step 820. Then the user can adjust the position of the printable image portion in step 830 to make sure the maximum printable image portion includes all the important information the user needs in the final print. If the user does not make any adjustment to the location of the common safe preview image portion, the location of the common safe preview portion is set to the default position. For example, the default position can be pre-set at the upper central location of the input image for a landscape image. The default location of the common safe preview portion is selected based on the consideration that a face in any input digital image tends to exist in the upper portion of an image and it is safer to print this upper portion of the input image than the lower portion. The final step 840 in FIG. 8 is to send the print order to an image receiver to print out the maximum printable image portion of the input image at the selected print format.

Although the above discloses “the safe cropping” in printing of an image from a preview image, the present invention is applicable to “safe cropping” from a previewed image to different output media. For example, a preview of an input image may be intended to be presented in soft electronic display at different image formats. The method described above can be used to produce a preview image for producing any of these output image media in one of a plurality of image formats. The procedure involves in providing a plurality of image formats for producing the output image media, calculating a viewable image portion of the input digital image for each image format on the output image media, determining a common safe preview portion of the digital image for all image formats on the output image media; and displaying the common safe preview portion of the digital image for preview prior to producing the output image media. In general, output image media can be a combination of hardcopy and soft display objects.

The above described invention is compatible with local or remote previewing and printing situations. The imaging software can be installed on a desktop computer or provided through a web browser over the Internet. The preview image can be displayed in both environments. The printing can be conducted local to the computer or the display device or at a remote location such as a central photofinishing lab.

A number of implementations of the invention have been described. Nevertheless, it will be understood that various modifications may be made without departing from the spirit and scope of the invention. For example, the operations of the processes and methods described here can be performed in a different order and still achieve desirable results. Also, the processes, methods, and systems described here can be used to change a variety of product attributes. Accordingly, other implementations are within the scope of the following claims.

1. A method for producing a preview image for printing an input digital image having a first aspect ratio, comprising
a) providing a print format having a second aspect ratio different from the first aspect ratio;
b) calculating a printable image portion of the input digital image for the print format; and
c) displaying the printable image portion of the digital image for preview prior to printing an image print at the print format.

2. The method of claim 1, wherein calculating a printable image portion of the input digital image for the print format includes calculating the first aspect ratio of the input digital image.

3. The method of claim 1, wherein calculating a printable image portion of the input digital image for the print format includes calculating the second aspect ratio of the print format.

4. The method of claim 1, wherein calculating a printable image portion of the input digital image for the print format includes calculating the maximum printable image portion of the input digital image for the print format.

5. The method of claim 1, wherein calculating a printable image portion of the input digital image for the print format includes calculating one or more unprintable image portions in the input digital image.

6. The method of claim 1, wherein the calculated printable image portion of the input digital image is smaller than the input digital image.

7. The method of claim 1, wherein the location of the printable image portion of the input digital image is selectable within the input digital image for preview prior to printing the image print at the print format.

8. The method of claim 1, wherein the default location of the calculated maximum printable image portion of the input digital image aligns with the input digital image at the upper left corner of the input digital image.

9. The method of claim 1 further comprising
d) providing the printable image portion of the input digital image to a digital printer; and
e) printing the image print at the print format by the digital printer.

10. A method for producing a preview image for printing an image print at one of a plurality of print formats in response to an input digital image, comprising
a) providing a plurality of print formats for printing the input digital image;
b) calculating a printable image portion of the input digital image for each print format;
c) determining a common safe preview portion of the digital image for all print formats; and
d) displaying the common safe preview portion of the digital image for preview prior to printing the image print.

11. The method of claim 10, wherein calculating a printable image portion of the input digital image for each print format includes calculating the aspect ratio of the input digital image.

12. The method of claim 10, wherein calculating a printable image portion of the input digital image for each print format includes calculating the aspect ratio for each of the provided print formats.

13. The method of claim 10, wherein calculating a printable image portion of the input digital image for each print format includes calculating the maximum printable image portion of the input digital image for the print format.

14. The method of claim 10, wherein determining a common safe preview portion of the digital image for all print formats includes calculating the overlapping area of the maximum printable image portions of the digital image for all print formats.

15. The method of claim 10, wherein the common safe preview portion of the input digital image is smaller than the input digital image.

16. The method of claim 10, wherein the location of the common safe preview portion of the input digital image is selectable within the input digital image for preview prior to printing the image print at the print format.

17. The method of claim 10, where in the default location of the common safe preview portion of the input digital image is set at the upper left corner of the input digital image.

18. The method of claim 10 further comprising
e) selecting one of the plurality of print formats;
f) providing the printable image portion of the input digital image for the selected print format to a digital printer; and
g) printing the image print at the selected print format by the digital printer.

19. A method for producing a preview image for printing an input digital image having an image border, comprising
a) providing a print format for printing the input digital image;
b) selecting an image border to be printed with the input digital image at the print format;
c) calculating a printable image portion of the input digital image for the selected image border and the print format; and
d) displaying the printable portion of the input digital image and the image border for preview prior to printing an image print having the image border at the print format.

20. The method of claim 19 further comprising
e) selecting a print format;
f) providing the printable image portion of the input digital image for the selected print format to a digital printer; and
g) printing the image print at the selected print format by the digital printer.

21. The method of claim 19, wherein calculating a printable image portion of the input digital image for the selected image border and the print format includes calculating an effective aspect ratio of the visible image area of the input digital image within the selected image border at the print format.

22. A method for producing a preview image for printing an input digital image having an image border, comprising
a) providing a plurality of print formats for printing the input digital image;
b) selecting an image border to be printed with the input digital image;
c) calculating a printable image portion of the input digital image for the selected image border at each the print format;
d) determining the common safe preview portion of the input digital image for the selected image border for all the print formats; and
e) displaying the common safe preview portion of the digital image for preview prior to printing an image print at the print format.

23. The method of claim 22 further comprising
f) selecting one of the plurality print formats;
g) providing the printable image portion of the input digital image for the selected print format to a digital printer; and
h) printing the image print at the selected print format by the digital printer.

24. The method of claim 22, wherein calculating a printable image portion of the input digital image for the selected image border at each print format includes calculating an effective aspect ratio of the visible image area of the input digital image within the selected image border at each print format.

25. A method for producing a preview image for producing an output image media in one of a plurality of image formats in response to an input digital image, comprising
a) providing a plurality of image formats for producing the output image media;
b) calculating a viewable image portion of the input digital image for each image format on the output image media;
c) determining a common safe preview portion of the digital image for all image formats on the output image media; and
d) displaying the common safe preview portion of the digital image for preview prior to producing the output image media.

26. A system for producing a preview image for printing an image print at a plurality of print formats in response to an input digital image, comprising
a) one or more digital printers capable of printing the input digital image at a plurality of print formats;
b) a computer apparatus for calculating a printable image portion of the input digital image for each print format and determining a common safe preview portion of the digital image for all print formats; and
c) a display device adapted to display the common safe preview portion of the digital image for preview prior to printing an image print at one of the print formats.

27. The system of claim 26, wherein the computer apparatus provides the printable image portion of the input digital image for the selected print format to the digital printer so that the image print can be printed by the digital printer at the print format.

28. The method of claim 27, further comprising
d) a digital printer for printing the image print at a selected print format based on the common safe preview portion of the digital image.
